(19) United States
(12) Patent Application Publication
(10) Pub. No.: US 2002/0071586 A1
(43) Pub. Date: Jun. 13, 2002

(54) Structure of earphone

(76) Inventor: Charles Pao-Hui Sung, Taipei Hsien (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 09/734,909

(22) Filed: Dec. 13, 2000

(51) Int. Cl. H04R 25/00

(52) U.S. Cl. 381/371; 381/370; 381/374; 381/375

(57) ABSTRACT

An improved structure of earphone comprising a sound putting out earplug, a microphone and an intermediate connecting bar, wherein, the connecting bar includes several sections pivotally and foldably connected with each other; thereby, the microphone can be collapsed when in use to be effectively gotten close to one's mouth, so that communication is clear, and can be collapsed to reduce volume for storage when not in use.

### BACKGROUND OF THE INVENTION

The present invention relates to improvement of earphone, and especially to an improved structure of earphone with excellent quality of communication, and being small, light and easy for storage.

Since inventing of earphones, they have been the most preliminary auxiliary instruments for music enjoyment; they have gone through the prevailing periods of phonographs, radios, records, walkmans etc., thereby, so they are variant in structural function or change of appearance. In the recent years, application on multimedia for computers and popularization of mobile phones make people continuously weed through the old earphones and bring forth the new ones; wherein, not only practicable earphones which are convenient and getting more and more humanistic in use are provided to satisfy the psychological renewing of people, but even more importantly, products of earphones are made to be leading in and to keep their competitive markets, and these are the subjects toward them the manufacturers vie with each other in doing study and development.

A conventional hands-free earphone is comprised mainly of a sound putting out earplug and a microphone. The earplug and the microphone are often connected via a conductor; they are hung freely near the mouth, quality of sound receiving thereby is inferior. One can get better quality of sound receiving by holding them with a hand; however, this may render the work on hand abrupt. A more advanced improvement such as Taiwan patent No.352892 “Improved structure of earphone and microphone” is comprised of an earplug which is connected with an extension body provided therein with a microphone and a sound conducting pipe. In application, the microphone can be fixedly held near the mouth, however, volume of the whole structure is enlarged and is less convenient than that before being improved, moreover, the design of connection between the output line and the microphone thereof renders wearing of the structure limited to one side, it is not so mobile as that before being improved.

### SUMMARY OF THE INVENTION

In view of the above defects, the inventor provided the present invention after profound study and improvement based on many experiments.

The object of the present invention is to provide an improved structure of earphone with excellent quality of communication, and being small, light and easy for storage.

The secondary object of the present invention is to provide an improved structure of earphone which is more humanistic in use, either of the right or the left ears can use it without limitation of orientation.

To get the above stated objects, the improved structure of earphone of the present invention is comprised mainly of a sound putting out earplug, a microphone and an intermediate connecting bar. Wherein, the connecting bar includes several sections pivotally and foldably connected with each other. Thereby, the microphone can be collapsed when in use to be effectively gotten close to the mouth, so that communication can be clear; and can be collapsed to reduce volume when not in use for storage.

The present invention will be apparent in its combination and operational features after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is a front view of the present invention;

FIG. 3 is a rear view of the present invention;

FIG. 4 is a schematic view showing application of the present invention;

FIG. 5 is a schematic view showing reducing volume by collapsing of the present invention.

### DETAILED DESCRIPTION OF THE PREFERRED EMBODIMENT

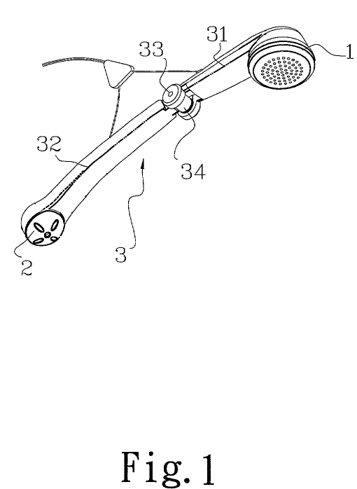

Referring to FIG. 1, the improved structure of earphone of the present invention is comprised mainly of a sound putting out earplug 1, a microphone 2 and an intermediate connecting bar 3.

Wherein, the earplug 1 is provided on one end thereof with an integrally connected shorter streamline bar 31 having on the front end thereof a pivot portion 33. The microphone 2 is also provided correspondingly with an integrally connected shorter streamline bar 32 having on the front end thereof a pivot portion 34. The shorter streamline bars 31, 32 are pivotally connected to form the intermediate connecting bar 3.

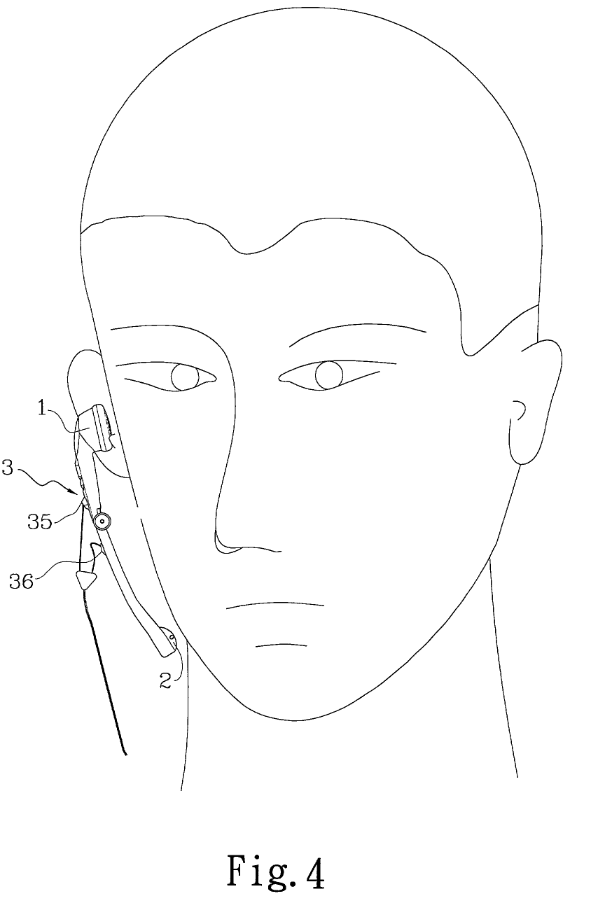

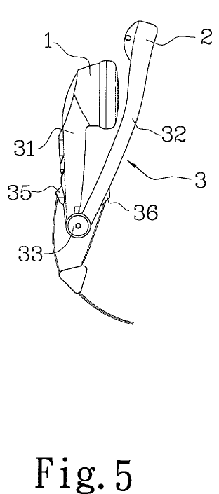

Thereby, as shown in FIGS. 4 and 5, the microphone 2 can be collapsed when in use to be effectively gotten close to the mouth, so that communication can be clear; and can be collapsed to reduce volume when not in use for storage.

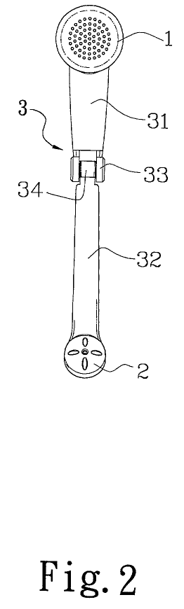

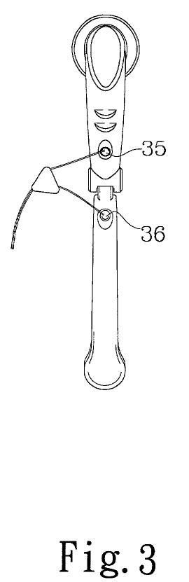

Further referring to FIGS. 2 and 3, the rear surfaces of the shorter streamline bars 31, 32 can be provided respectively with line outlets 35, 36 to allow outgoing of electric wires which then connect with each other outside. In this way, the earphone can be worn on either of the right and left ears, thus effectively overcome the defect of limitation of orientation of conventional line outgoing structures.

The microphone 2 can also be provided with a flexible shorter bar having also on the front end thereof a pivot portion; or the microphone 2 can be provided on a hollow cylindrical bar; so that the a user can adjust the microphone 2 to be at any suitable position taking advantage of the flexible shorter bar when in use, and can collapse the flexible shorter bar or hollow cylindrical bar to be almost lapped over the earplug 1 when not in use, this can reduce volume for storage.

The structure of earphone of the present invention has the following advantages:

1. It can make gain of communication quality when in use.

2. Volume of it can be small in favor of carrying and storage.

3. It has no limitation in orientation, and can be used for either of the two ears.

In conclusion, the novel structure of the present invention is evidently advanced in comparison with conventional structures, it has never existed in the markets or appeared on publications, and it is industrial valuable.

Having thus described my invention, what I claim as new and desire to be secured by Letters Patent of the United States are:

1. An improved structure of earphone comprising:
a sound putting out earplug, a microphone and an intermediate connecting bar, wherein, said connecting bar includes several sections pivotally and foldably connected with each other; thereby, said microphone is adapted for collapsing when in use to be effectively gotten close to one's mouth, so that communication is clear, and is adapted for collapsing to reduce volume for storage when not in use.

2. An improved structure of earphone as defined in claim 1, wherein,
said earplug is provided on one end thereof with an integrally connected shorter streamline bar having on the front end thereof a pivot portion, said microphone is also provided correspondingly with an integrally connected shorter streamline bar having on the front end thereof a pivot portion, the rear surfaces of said two shorter streamline bars are provided respectively with two line outlets.

3. An improved structure of earphone as defined in claim 2, wherein,
said shorter bar of said microphone is flexible.

4. An improved structure of earphone as defined in claim 2, wherein,
said shorter bar of said microphone is a hollow cylindrical bar.
